(19) United States
(12) Patent Application Publication
(10) Pub. No.: US 2004/0069554 A1
(43) Pub. Date: Apr. 15, 2004

(54) Apparatus for receiving a robot driver in a motor vehicle

(76) Inventor: Kurt Staehle, Neuhausen-Steinegg (DE)

Correspondence Address: BROWDY AND NEIMARK, P.L.L.C., 624 Ninth Street, N.W., Washington, DC, 20001, US

(21) Appl. No.: 10/629,856

(22) Filed: Jul. 30, 2003

(30) Foreign Application Priority Data
Jul. 31, 2002 (DE) 103 31 800.6

(51) Int. Cl. B60R 21/00

(52) U.S. Cl. 180/268

(57) ABSTRACT

An apparatus for receiving a robot driver in a motor vehicle having a driver's seat and a driver's lap belt, composed of:a mounting portion adapted to rest on the driver's seat for supporting the robot driver; and at least one locking element carried by the mounting portion and engageable with the driver's lap belt for holding the mounting portion securely on the driver's seat vehicle in a position suitable for proper operation of the robot driver.

### BACKGROUND OF THE INVENTION

The invention relates to an apparatus for receiving a robot driver in a motor vehicle.

Robot drivers are known, as disclosed, for instance, in German Patent Disclosure DE 39 40 588 A1. As a rule, they comprise a housing that is to be secured on the driver's seat, and actuating elements, secured to this housing, for the steering wheel and/or the foot pedals of the motor vehicle.

For connecting this housing to the driver's seat, there is provided a seat plate having a seat portion and a backrest portion. The seat plate can be adapted to the particular driver's seat by an adjustable-length support device.

The precision and effectiveness of the displacement motions that occur during proper operation of such a robot driver also depend on the accuracy of the positioning of the robot driver on the driver's seat and on maintaining this position. As a rule, each robot driver is thus assigned a kind of underlay or support device, with which it is positioned more or less reliably and permanently for the intended use on the driver's seat.

In an individual case, this requires adjustment work, for instance for horizontally aligning the robot driver with what is often a relatively soft, yielding driver's seat.

In the reference cited above, this problem is solved by a support rod that braces the robot driver at the steering wheel and introduces the forces of reaction that occur in robot driver operation into the steering axis. For this purpose as well, individualized adaptation and setting are necessary.

### BRIEF SUMMARY OF THE INVENTION

An object of the invention is to position and fix a robot driver in a manner that provides a simpler and yet stable, reliable basis for retaining a robot driver, while the robot driver does not need its own fastening devices, support devices, or other retention devices.

The invention provides an apparatus for receiving a robot driver in a motor vehicle having a driver's seat and a driver's lap belt, comprising:

a mounting portion adapted to rest on the driver's seat for supporting the robot driver; and

at least one locking element carried by the mounting portion and engageable with the driver's lap belt for holding the mounting portion securely on the driver's seat vehicle in a position suitable for proper operation of the robot driver.

Thus, according to the invention, instead of robot driver-specific retention or support devices, the driver's seat belt that is already present in all vehicles is used for fixation and adjustment. Instead of vehicle- and robot-specific support means, simple retaining elements for the driver's seat belt can be used, whose function is thus usefully expanded.

In a preferred form of construction, two structurally identical retaining elements are provided, to which the two end portions of the driver's lap belt are fixed and tightened in such a way that both firm retention of the apparatus and an adjustment of the seat portion serving as a mounting plate in a horizontal direction is attained with only a few manipulations, so that then by means of arbitrary detent, screw or clamp connections, the actual driver's seat belt, which is not a separate subject of the invention, can be placed on the apparatus according to the invention, and support or retention devices on components of the motor vehicle can then be dispensed with.

A particular advantage of the invention is thus that driver's seat belts of varying design and with varying ranges of function can be reliably secured to the driver's seat by way of an apparatus that has been “standardized” according to the invention to be used as a mounting means.

Further advantageous features will be described below.

### BRIEF DESCRIPTION OF THE DRAWINGS

One preferred exemplary embodiment of the apparatus of the invention will now be described in further detail in conjunction with the following drawings.

FIG. 1A is a perspective view of the preferred embodiment of the apparatus of the invention with its essential components.

FIG. 1B is a perspective view of the embodiment of the invention, viewed from below, with several components (support profile 15 and adjusting element 31)) removed to allow viewing of other components.

FIG. 2 is a front elevational view of the apparatus of FIGS. 1A and 1B in the direction arrow A of FIGS. 1A and 1B.

FIG. 3 is a perspective view of a first locking element of FIGS. 1 and 2.

FIG. 4 is a perspective view of a second locking element of FIGS. 1 and 2.

FIGS. 5A and 5B are a plan view and side elevational view, respectively, of the apparatus of the invention.

FIGS. 6A and 6B are side elevational detail views showing components of the embodiment in two different operating states.

FIGS. 7A and 7B are side elevational detail views showing other components of the embodiment in two different operating states.

### DETAILED DESCRIPTION OFTHE INVENTION

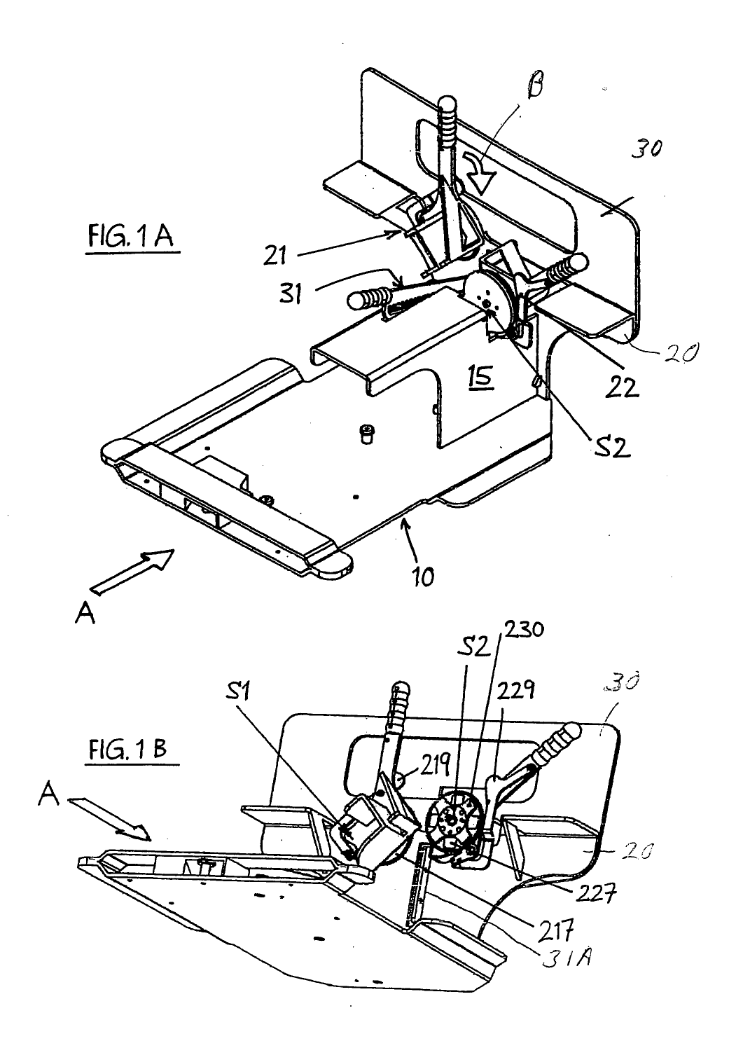

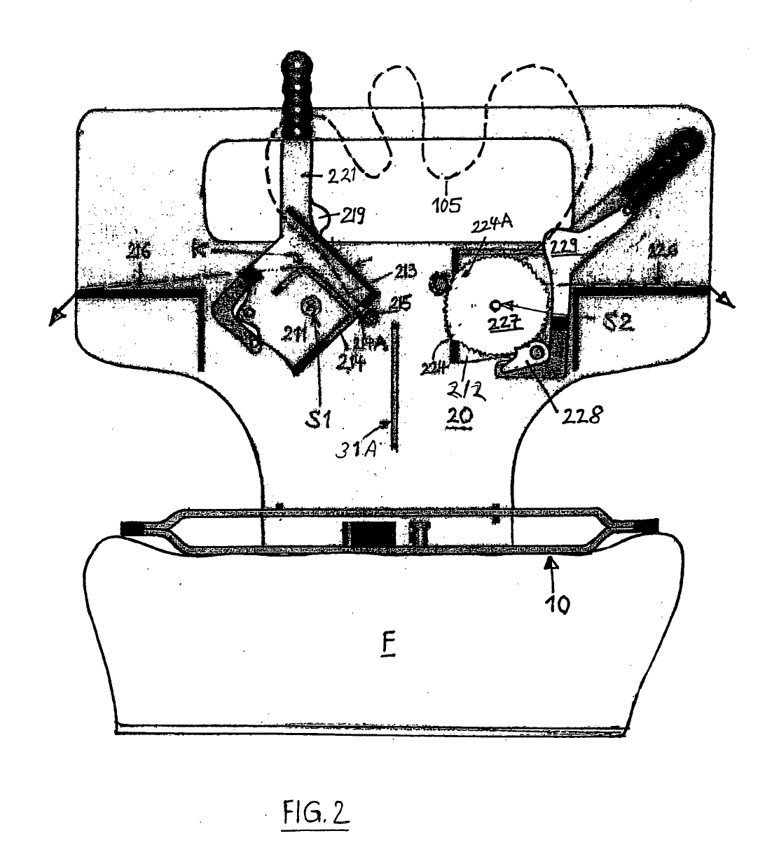

Referring to the drawings as a group, the apparatus of the invention comprises a seat plate 10 constituting a mounting plate for the robot driver and arranged to be placed on the driver's seat bottom F. A support profile 15 (not shown in FIG. 1B or 2) extends vertically upwardly from plate 11 and supports a locking plate 20 for receiving two locking elements 21 and 22, as well as a backrest plate 30 that is pivotable about a horizontal axis at the rear end of plate 10 to vary its angular inclination a relative to the locking plate 20 by means of an adjusting element 31 for adaptation to the relative inclination between the driver's seat F and the driver's seat back L. Backrest plate 31 is provided with a fastening element 31A that forms a hinge connection with the end of element 31.

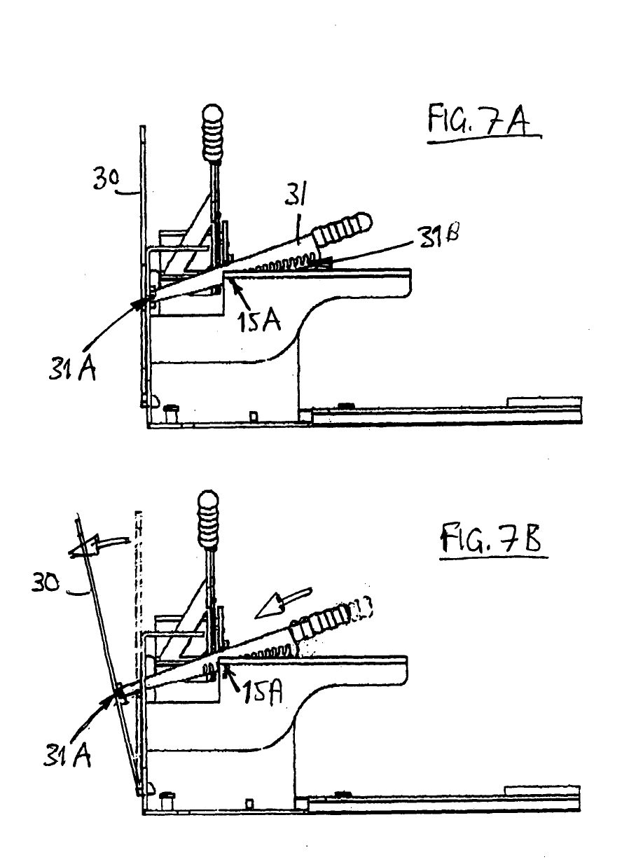

Referring to FIGS. 1A, 7A and 7B, the top surface of plate 15 is provided with a slot (visible in FIG. 1A) into which adjusting element 31 extends and plate 15 is provided with a locking bar, or pin, 15A that extends across the slot. Element 31 is formed with a detent mechanism 31B composed of a series of teeth that are spaced apart to define recesses. Bar 15A can engage in any selected recess to hold backrest plate 30 in a desired angular position.

Seat plate 10 has fastening means, such as bolts, pins or the like, with which a robot driver can be secured, and it thus serves as a mounting plate.

In the locking plate 20, pivot shafts S1 and S2 are retained essentially parallel to the plane of the seat plate 10, and the first locking element 21 and the second locking element 22 are pivotable about shafts S1 and S2, respectively, counter to one another, element 21 being pivotable in the direction represented by arrow B in FIG. 1A. The locking elements serve to receive and tighten the lap belt portion 105 of a conventional driver's seat belt (FIG. 2) and thus form the central functional components of the apparatus of the invention. These components will now be described in further detail.

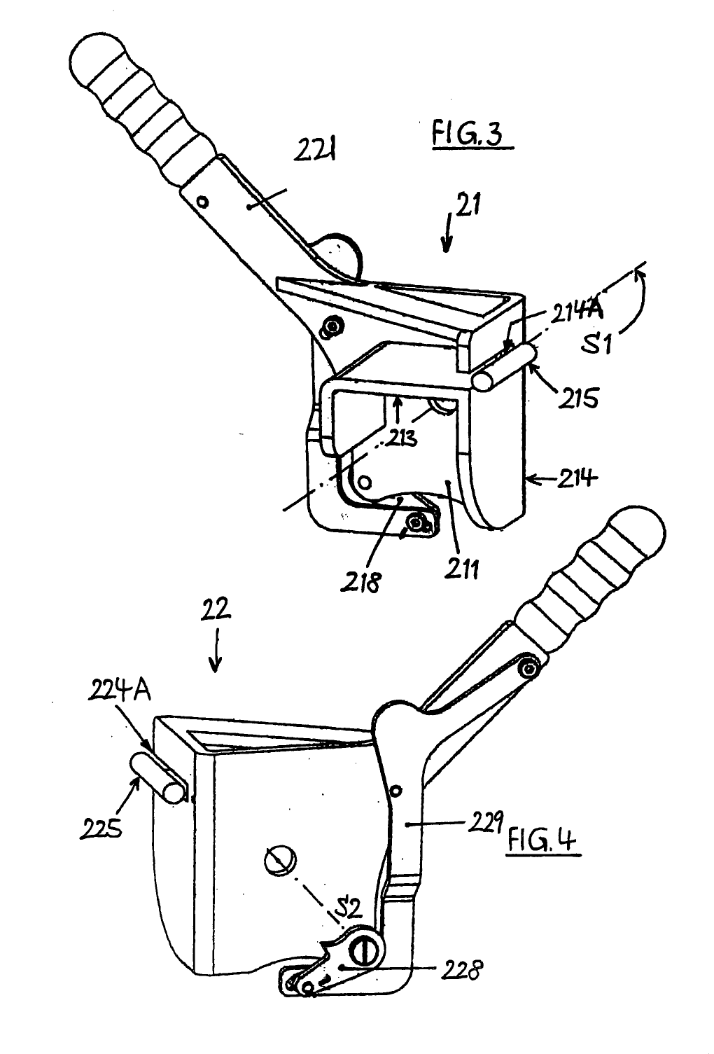

The two locking elements 21 and 22, in the exemplary embodiment shown, are structurally identical, or mirror-symmetrical, and their structure is shown most clearly in FIGS. 2-4. They are mirror-offset from one another or rotated in the locking plate 20 of the apparatus, supported pivotably about the pivot shafts S1 and S2, respectively. However, elements 21 and 22 need not be structurally identical to one another.

Each locking element 21, 22 contains a respective base plate 211, 212, which may have an essentially rectangular form, as shown, and is retained in a plane perpendicular to the respective pivot shaft S1, S2. From a corner region of each base plate, a respective grip portion 221, 222 extends in the direction of the diagonal. This grip portion 221, 222 ends in a handle for pivoting the respective locking element 21, 22 about its respective pivot shaft S1, S2.

In order to be able to generate tightening of the lap belt portion 105 by this pivoting, the following components are provided.

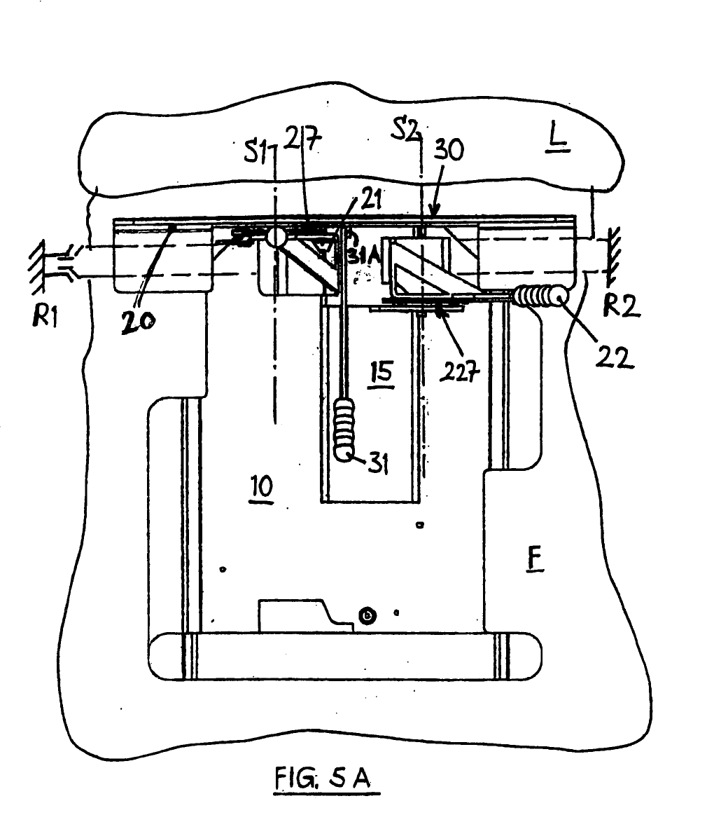

A tightening plate is mounted on each base plate 211, 212 to extend perpendicularly to its respective base plate. The drawing shows tightening plate 213 associated with base plate 211. The corresponding tightening plate for base plate 212 is not provided with a reference numeral. Each tightening plate is retained outside of its associated pivot shaft S1, S2. One longitudinal edge of tightening plate 213 merges into a front plate 214 having a slit 214A. As shown in FIG. 4, the tightening plate associated with base plate 212 merges into a corresponding front plate having a slit 224A.

Retaining brackets 215, 225 are provided as clamping elements located immediately in front of the respective slit 214A, 224A. The disposition of these components is such that, as shown in FIG. 2, one part of lap belt portion 105 is placed, after a loop has been formed, over tightening plate 213, through slit 214A and around bracket 215. Another part of lap belt portion 105 is placed over the tightening plate associated with base plate 212 and passed through slit 224A and around retaining bracket 225. As a result, a fixation is achieved that prevents lap belt portion 105 from slipping around retaining brackets 215 and 225.

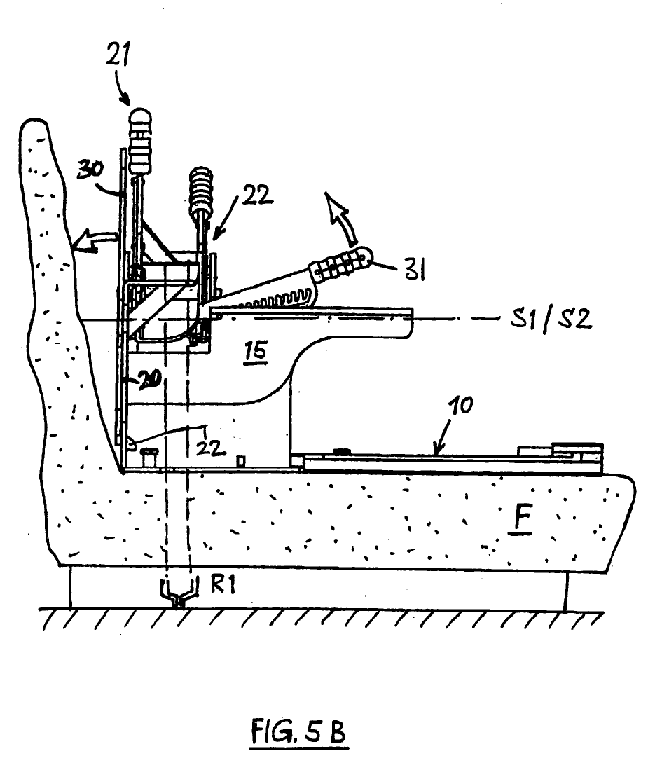

Approximately at the height of pivot shafts S1 and S2, guide plates 216 and 226 are carried by locking plate 20 at respective locations that are laterally offset from locking element 21 and 22, respectively. Lap belt portion 105, extending from belt fasteners R1 and R2, is guided before being placed in the two locking elements. The result in particular is the arrangement shown in FIGS. 2 and 5, in which the remaining middle portion of the lap belt 105 extends, without any mechanical function, in a loop between the two locking elements.

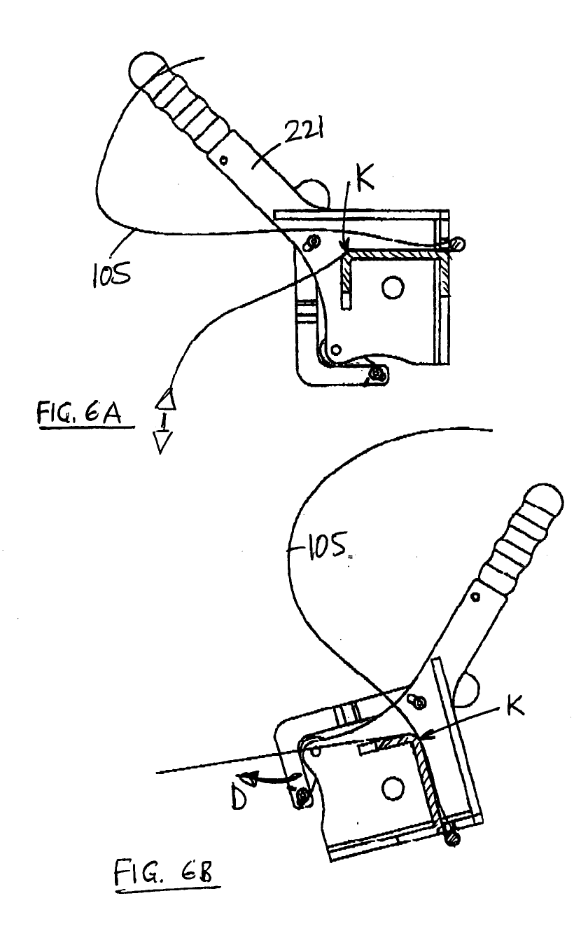

Gear wheels 217 and 227 are each fixed by a respective rotation-preventing plate 230 seated on a respective pivot shaft S1, S2, parallel to the respective base plate 211, 212. Two cantilevered arms 219, 229 each have one end pivotably connected to a respective grip portion 221, 222, and its other end pivotable connected to a respective latch 218, 228. Each arm 218, 229 cooperates with its respective latch 218, 228 in such a way that upon movement of a grip portion 221 or 222 in the direction indicated by arrow B in FIG. 1A, i.e. toward the other grip portion, the respective latch 218, 228 is indexed onward one tooth at a time in the respective gear wheel 217, 227 and blocks pivoting motion in the opposite direction. When a cantilevered arm 219, 229 is pressed inward, its associated latch 218, 228 becomes disengaged from the associated gear wheel 217, 227, and the associated grip portion 221, 222 can be pivoted backward; the lap belt portion 105 is then released. FIG. 6A shows locking element 21 in its release position and FIG. 6B shows locking element 21 in its locking position. To change from the locking position to the release position, latch 228 must be disengaged from gear wheel 227 by exerting pressure on cantilever arm 229 in the direction of arrow D in FIG. 6B.

Because of the geometry of guide plate 216, tightening plate 213, and retaining bracket 215, pivoting of the locking element 21 causes lap belt portion 105 to tighten, since the spacing between each fastening point R1 and R2 on a respective side of seat bottom F, on the one hand, and its associated retaining bracket 215 or 225, on the other, is increased continuously until a fixed, horizontal fixation of the seat plate 10 on the driver's seat F and thus a defined mounting plane for a robot driver is reached.

This geometry of the locking elements and their operation enables them to act as tightening levers, in which the tightening force for lap belt portion 105 to be brought to bear on the edge K of each tightening plate 213, 223, which edge is located laterally at a small distance from the associated pivot shaft S1, S2, is brought to bear via the handle located at a greater distance from the pivot shaft, creating a large mechanical advantage. As a result, strong tightening forces can be generated.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. An apparatus for receiving a robot driver in a motor vehicle having a driver's seat and a driver's lap belt, comprising:
a mounting portion adapted to rest on the driver's seat for supporting the robot driver; and
at least one locking element carried by said mounting portion and engageable with the driver's lap belt for holding said mounting portion securely on the driver's seat in a position suitable for proper operation of the robot driver.

2. The apparatus of claim 1, wherein said locking element has a grip handle.

3. The apparatus of claim 1, wherein said locking element comprises at least one component which guides and locks the lap belt.

4. The apparatus of claim 3, wherein the driver's lap belt is locked to the vehicle at at least one locking point and said locking element is movable about a pivot shaft in such a way that pivoting of said locking element varies the spacing between the locking point and said component.

5. The apparatus of claim 4, wherein said locking element has a grip handle, a gear wheel and a latch and said grip handle is maintained in a given angular position by said gear wheel and said latch when said locking element engages the driver's lap belt to hold said mounting portion securely on the driver's seat.

6. The apparatus of claim 5, further comprising a guide plate spaced laterally from said locking element in a position to guide the lap belt from the locking point to said component.

7. The apparatus of claim 1, further comprising a locking plate and wherein said at least one locking element comprises two structurally identical locking elements each provided for independently tightening a respective end of the lap belt and disposed offset from one another on said locking plate in such a way that, for locking the lap belt, said two locking elements undergo pivoting motions that are oriented counter to one another.

8. The apparatus of claim 7, wherein said locking elements pivotable about respective shafts in such a way that said locking elements act as tightening levers for the lap belt.

9. The apparatus of claim 1, further comprising a backrest portion that is pivotable relative to said mounting portion and is fixable at an angle relative to said mounting portion.
